(19) United States
(12) Patent Application Publication
(10) Pub. No.: US 2017/0029560 A1
(43) Pub. Date: Feb. 2, 2017

(54) STRESS CRACKING RESISTANT PET AND MANUFACTURE THEREOF

(71) Applicant: EQUIP0LYMERS GMBH, Schkopau (DE)

(72) Inventors: Rolf Eckert, Halle (DE); Marion Nagel, Mersburg (DE); Matthias Stolp, Merseburg (DE); Volkmar Voerckel, Merseburg (DE)

(21) Appl. No.: 15/106,229

(22) PCT Filed: Dec. 19, 2013
(86) PCT No.: PCT/EP2013/077502

§ 371 Date: Jun. 17, 2016

(51) Int. Cl. C08G 63/183; B29C 37/00; B29B 11/14; B29C 49/00

(52) U.S. Cl. CPC C08G 63/183; B29C 49/0005; B29C 49/0073; B29C 37/0025; B29B 11/14; C08G 2390/00; B29L 2031/7158

(57) ABSTRACT

The present invention relates to a specific polyethylene terephthalate (PET) allowing to produce a stretch blow molded PET bottle having superior resistance to environmental stress cracking when the inner or outer surface of the bottle is treated with stress cracking causing chemical substances and to a method of manufacturing such specific PET. The invention also relates to a stretch blow molded bottle made of such PET and a preform of such a bottle. The invention further relates to the use of the specific PET for the manufacture of a stretch blow molded PET bottle having said superior resistance to environmental stress cracking or the manufacture of a preform of such a PET bottle.

### CROSS-REFERENCE TO RELATED APPLICATIONS

This application is a national stage application of International Application Serial No. PCT/EP2013/077502, filed Dec. 19, 2013, which is incorporated by reference herein.

### BRIEF DESCRIPTION OF THE DRAWINGS

FIG. 1 shows three tensile bones made of PET having various molecular weights.

FIG. 2 shows four tensile bones made of PET containing DEC and IPA.

FIG. 3 shows two tensile bones made of PET with different concentrations of PeOH.

FIG. 4 shows three tensile bones after bending and applying acetone as stress cracking provoking chemical substance.

FIG. 5 shows three tensile bones made of PET having varying molecular weight after bending and applying acetone as stress cracking provoking chemical substance.

FIG. 6 shows three tensile bones made of PET having varying molecular weight after bending and applying acetone as stress cracking provoking chemical substance.

FIG. 7 shows five tensile bones made of PET IV after pretreament in various mixtures of acetone and water followed by bending and applying acetone as stress cracking provoking chemical substance.

FIGS. 8a-c show the first three tensile bones of FIG. 7 under a microscope without and with pretreatment after bending and applying acetone as stress cracking provoking chemical substance.

### DETAILED DESCRIPTION

The present invention relates to a specific polyethylene terephthalate (PET) allowing to produce a stretch blow molded PET bottle having superior resistance to environmental stress cracking when the inner or outer surface of the bottle is treated with stress cracking causing chemical substances and to a method of manufacturing such specific PET. The invention also relates to a stretch blow molded bottle made of such PET and a preform of such a bottle. The invention further relates to the use of the specific PET for the manufacture of a stretch blow molded PET bottle having said superior resistance to environmental stress cracking or the manufacture of a preform of such a PET bottle.

PET bottles are widely known to be used for filling of mineral water, juices, soft drinks and alcoholic or non-alcoholic beverages, each of which being carbonated or uncarbonated. The advantage of PET as material for the bottles is its gas barrier property, good transparency, heat resistance, and mechanical strength. PET bottles are manufactured by stretch blow molding a preform made of PET to obtain the PET bottle.

However, regarding the mechanical strength of stretch blow molded PET bottles it is known that there exists a problem with a so-called environmental stress cracking. The environmental stress cracking can be provoked by various chemical substances if at the same time the PET material is under tension force. Environmental stress cracking may occur at those areas of a PET bottle where the PET material is amorphous or has a very low degree of crystallinity. Parts of PET bottles are amorphous or have a low degree of crystallinity if they are unstretched or just slightly stretched like at the bottom area and at the neck area. The reason for this phenomenon is that stretching of PET leads to a partial crystallization of the previously amorphous PET material, by so-called “strain induced crystallization”.

At present and due to the great market success of PET bottles there are considerations and attempts to introduce these PET bottles into the market also as containers for consumer compositions, like hair spray, shaving foam, and other products containing various chemical substances. To date these consumer products are normally filled in pressurized dispensers, e.g. made of aluminum. As pressurized dispensers of aluminum becomes more and more unpopular because of their assumed environmental impact there is a demand of alternative containers having a better acceptability by the consumers.

However, the use of PET bottles as containers for the above mentioned consumer products is problematic since many chemical substances included in the consumer compositions are known to cause the above discussed environmental stress cracks, particularly at unstretched portions or just slightly stretched portions of PET bottles. Such portions are known to exist in the bottom area of PET bottles as well as in its neck area. In case of pressurized and chemical substances containing consumer products being filled in the containers there is a high risk of break or burst of the containers if being made of PET.

The present inventors have previously found in another invention that by performing a specific method of manufacturing a stretch blow molded PET bottle a bottle can be obtained having an improved resistance against environmental stress cracking and, as a consequence, against breaking or bursting which could be caused by filling the bottle with pressurized and chemical substances containing consumer products.

This method of manufacturing such an improved PET bottle comprises the steps of:
a) providing a stretch blow molded PET bottle, and
b) pretreating at least those parts of the stretch blow molded PET bottle where its PET material is amorphous or has an insufficient degree of crystallinity with an organic solvent or an aqueous solution of the organic solvent. By pretreating the PET with an organic solvent or an aqueous solution of the organic solvent a PET is obtained having an outer layer of solvent induced crystallized PET.

The crystallinity of the PET material of a stretch blow molded PET bottle is typically generated by strain induced crystallization. However, crystallinity in PET bottles can also, or in addition, be generated by other methods like so-called heat set. For example, if a preform is stretch blow molded and the mold is heated to a certain temperature the resulting bottle will comprise crystallinity formed by strain induced crystallization as well as crystallinity formed by thermally induced crystallization. Both kinds of crystallinity can at least partially overlay or interfere with each other.

In context of the above mentioned invention the inventors have observed that the degree of improvement of the resistance to environmental stress cracking of treated stretch blow molded PET bottles seems not- or only to a less extent- dependent from the type of PET used for the manufacture of the PET bottles. Nonetheless, PET bottles made of specific types of PET may show an even stronger resistance to environmental stress cracking than bottles made of other types of PET. In any case the treatment procedure of the present invention results in an improvement of the resistance to environmental stress cracking of the treated PET bottles compared to the situation where such treatment has not been performed.

In the present invention the inventors have identified specific PETs showing a superior performance with respect to resistance to environmental stress cracking of bottles made of these specific PETs—irrespective whether or not the bottles have been pretreated with the above mentioned organic solvent or an aqueous solution of such an organic solvent.

These specific PETs are characterized by a specific combination of DEC and IPA comonomer content and the presence of PeOH (pentaerythritol) as a further comonomer. Additional factors which may have an improving influence to the stress cracking performance are the intrinsic viscosity (IV), the presence of long chain branching (LCB) agents and a specific amount of COOH end groups.

So, the inventors have surprisingly found that a PET comprising comonomer contents of 0 to 2.5% by weight IPA, 1 to 2% by weight DEC and 0.005 to 0.1% by weight PeOH, each based on the weight of the final polymer PET, show a superior performance with respect to resistance to environmental stress cracking of bottles made of these specific PETs.

A further improvement is achievable when the PET has an intrinsic viscosity IV in the range of 0.8 to 1.2 dl/g, preferably in the range of 0.9 to 1.1 dl/g.

Preferably, the PET comprises 0.1 to 1.0% by weight IPA, and/or 1.3 to 1.8% by weight DEC and/or 0.01 to 0.05% by weight PeOH, each based on the weight of the final polymer PET.

An additional improvement may be achieved when the PET has a specific amount of COOH end groups, represented by an a-value in the range of 0.25 to 0.45, preferably 0.30 to 0.40.

A further improvement is achievable when one or more long chain branching agents present in the polycondensation reaction are used. Examples for such long chain branching agents are tri- and tetrafunctional polyols.

The PET according to the present invention is typically manufactured in a polycondensation reaction catalyzed by the use of an antimony catalyst in an amount of 150 to 350 ppm by weight, preferably in an amount of 200 to 300 ppm by weight, based on elemental Sb in the final polymer.

A further aspect of the invention is a method of manufacturing a treated stretch blow molded PET bottle having an improved resistance to environmental stress cracking, the method comprises the steps of:
a) providing a stretch blow molded PET bottle, and
b) treating at least those parts of the stretch blow molded PET bottle where its PET material is amorphous or has an insufficient degree of crystallinity with i) an organic solvent or ii) an aqueous solution of the organic solvent for a time in the range of 1 second to less than 1 hour, wherein the bottle is made of the PET according to the present invention and described above.

The bottle manufactured according to this method has an improved resistance to environmental stress cracking at its treated parts, including those parts of the bottle where its PET material was amorphous or had an insufficient degree of crystallinity before treating.

The method of manufacturing a treated stretch blow molded PET bottle according to the invention also comprise, as an alternative to the step of treating the stretch blow molded PET bottle with the organic solvent or the aqueous solution of the organic solvent, the steps of treating the PET preform of the bottle and stretch blow molding this preform to obtain the stretch blow molded PET bottle, wherein at least parts of the preform are treated with the above described organic solvent or the aqueous solution of the organic solvent, namely those parts which result after stretch blow molding in parts of the bottle where its PET material would be amorphous or would have an insufficient degree of crystallinity if the preform would not be treated.

In order to clarify, the preceding paragraph refers to and discloses an alternative embodiment of the inventive method, wherein steps a) and b) are replaced by the steps of:
a′) providing a preform of a PET bottle,
b′) treating with i) an organic solvent or ii) an aqueous solution of the organic solvent at least those parts of the preform which result after stretch blow molding in parts of the bottle where its PET material would be amorphous or would have an insufficient degree of crystallinity if the preform would not be treated, and
c′) stretch blow molding the treated preform to obtain the stretch blow molded PET bottle, wherein the treatment is carried out for a time in the range of 1 second to less than 1 hour, preferably in the range of 3 seconds to less than 20 minutes, more preferably in the range of 5 seconds to less than 10 minutes, most preferably in the range of 10 second to less than 5 minutes.

Also the bottle manufactured according to this alternative embodiment of the inventive method has an improved resistance to environmental stress cracking at its unstretched parts or slightly stretched parts when the inner or outer surface of the bottle is treated with one or more of the chemical substances known to cause environmental stress cracking.

The organic solvent used to treat the preform or the bottle as described above is preferably selected from the group consisting of acetone, ethyl acetate, methyl propyl ketone, toluene, 2-propanol, pentane, methanol, and mixtures thereof. Preferred is acetone or ethyl acetate or mixtures thereof.

Correspondingly, the aqueous solution of the organic solvent used to treat the preform or the bottle is preferably a mixture of water with an organic solvent selected from the group consisting of acetone, ethyl acetate, methyl propyl ketone, toluene, 2-propanol, pentane, methanol, and mixtures thereof.

In a preferred embodiment of the inventive method the organic solvent or the aqueous solution of the organic solvent is acetone with a volume ratio of acetone to water in the range of 40:60 to 100:0. In general, using undiluted acetone is most efficient in improving the resistance to environmental stress cracking. However, due to the flammability of acetone and possible negative health effects it is preferred to dilute the acetone as much as possible. Therefore, the volume ratio of acetone to water is preferably in the range of 50:50 to 90:10, more preferably in the range of 60:40 to 80:20, most preferably in the range of 60:40 to 70:30.

In a further preferred embodiment of the inventive method the organic solvent or the aqueous solution of the organic solvent comprises ethyl acetate in an amount of 0.5 to 98.5% by weight and acetone in an amount of 1.5 to 99.5% by weight and water in an amount of 0 to 98% by weight, each based on the total weight of the organic solvent or the aqueous solution.

In an even more preferred embodiment the organic solvent or the aqueous solution of the organic solvent comprises ethyl acetate in an amount of 5 to 85% by weight and acetone in an amount of 15 to 95% by weight and water in an amount of 0 to 80% by weight, each based on the total weight of the organic solvent or the aqueous solution.

In general and as in the case of pure acetone, using an undiluted mixture of ethyl acetate and acetone is most efficient in improving the resistance to environmental stress cracking. However, due to the flammability of acetone and ethyl acetate and possible negative health effects it is preferred to dilute the mixture of ethyl acetate and acetone as much as possible. Therefore, in a preferred embodiment the organic solvent or the aqueous solution of the organic solvent comprises ethyl acetate in an amount of 5 to 75% by weight and acetone in an amount of 15 to 85% by weight and water in an amount of 10 to 80% by weight, each based on the total weight of the organic solvent or the aqueous solution.

In a particularly preferred embodiment the organic solvent or the aqueous solution of the organic solvent comprises ethyl acetate in an amount of 7.5 to 77.5% by weight and acetone in an amount of 22.5 to 92.5% by weight and water in an amount of 0 to 70% by weight, each based on the total weight of the organic solvent or the aqueous solution. In another preferred embodiment, for the reasons mentioned above with respect to the diluted mixtures, the organic solvent or the aqueous solution of the organic solvent comprises ethyl acetate in an amount of 7.5 to 57.5% by weight and acetone in an amount of 22.5 to 72.5% by weight and water in an amount of 20 to 70% by weight, each based on the total weight of the organic solvent or the aqueous solution.

In a most preferred embodiment the organic solvent or the aqueous solution of the organic solvent comprises ethyl acetate in an amount of 10 to 70% by weight and acetone in an amount of 30 to 90% by weight and water in an amount of 0 to 60% by weight, each based on the total weight of the organic solvent or the aqueous solution. In another preferred embodiment, for the reasons mentioned above with respect to the diluted mixtures, the organic solvent or the aqueous solution of the organic solvent comprises ethyl acetate in an amount of 10 to 40% by weight and acetone in an amount of 30 to 60% by weight and water in an amount of 30 to 60% by weight, each based on the total weight of the organic solvent or the aqueous solution.

Regarding the step of treating at least those parts of the stretch blow molded PET bottle where its PET material is amorphous or has an insufficient degree of crystallinity or at least those parts of the preform which result after stretch blow molding in parts of the bottle where its PET material would be amorphous or would have an insufficient degree of crystallinity if the preform would not be treated many different treating methods can be performed.

One preferred method is that at least those parts of the preform that will not be stretched or will just slightly be stretched during blow molding the bottle or at least the unstretched or just slightly stretched parts of the bottle, i.e. those parts as defined in the claims, are immerged in a bath of the organic solvent or the aqueous solution of the organic solvent. The immerging is carried out for a time in the range of 1 second to less than 1 hour or a preferred time as already mentioned above. The time of immerging can be less than 1 second if the time of remaining on the surface of the preform or the bottle prior to evaporation of the solvent or the aqueous solution of the solvent is in the range of 1 second to less than 1 hour or a preferred time as already mentioned above.

In general, the time of remaining on the surface of the preform or the bottle prior to evaporation of the solvent or the aqueous solution of the solvent is defined as the time of treating.

Another preferred method is that the parts of the preform or of the bottle as defined above are wetted with a sponge or textile soaked with the organic solvent or the aqueous solution of the organic solvent. The wetting is carried out for a time in the range of 1 second to less than 1 hour or a preferred time as already mentioned above. The time of wetting can be less than 1 second if the time of remaining on the surface of the preform or the bottle prior to evaporation of the solvent or the aqueous solution of the solvent is in the range of 1 second to less than 1 hour or a preferred time as already mentioned above.

A further preferred method is that the organic solvent or the aqueous solution of the organic solvent is sprayed onto the parts of the preform or of the bottle as defined above. The time of spraying can be less than 1 second if the time of remaining on the surface of the preform or the bottle prior to evaporation of the solvent or the aqueous solution of the solvent is in the range of 1 second to less than 1 hour or a preferred time as already mentioned above.

The temperature of the organic solvent or the aqueous solution of the organic solvent applied to for treating the preform or the bottle can vary within broad ranges, i.e. above the melting point up to below the boiling point of the respective organic solvent or the aqueous solution of the organic solvent. However, a preferred temperature is in the range of 5 to 40° C., more preferably in the range of 10 to 30° C., most preferably in the range of 15 to 25° C. Also the temperature of the preform or of the bottle or of those parts of the preform or the bottle which are treated can vary within broad ranges during treatment. Preferably, the temperature of the preform or of the bottle or of those parts of the preform or the bottle which are treated during treatment is in the range of 5 to 40° C., more preferably in the range of 10 to 30° C., most preferably in the range of 15 to 25° C.

A further aspect of the invention is a PET bottle made of the specific PET described above or being manufactured by the method described above.

According to this aspect of the invention the PET bottle preferably has a complete outer layer of solvent induced crystallized PET, wherein the outer layer of solvent induced crystallized PET has a thickness in the range of 3 to 200 μm, preferably in the range of 5 to 160 μm, more preferably in the range of 10 to 120 μm, most preferably in the range of 15 to 80 μm, measured under a microscope at a cross section of the bottle wall or the preform wall in polarized light. The PET bottle can be, preferably, manufactured by the above described method.

Preferably, the complete outer layer of solvent induced crystallized PET is at least at those parts where the PET bottle comprises amorphous PET material or where the PET material has an insufficient degree of crystallinity over the whole thickness of the PET material.

A still further aspect of the invention is a PET preform made of the specific PET described above, the preform being suitable for the manufacture of a PET bottle by stretch blow molding the preform.

According to this aspect of the invention the PET preform preferably has at least in part a complete outer layer of solvent induced crystallized PET, wherein the outer layer of the solvent induced crystallized PET has a thickness in the range of 3 to 200 μm, preferably in the range of 5 to 160 μm, more preferably in the range of 10 to 120 μm, most preferably in the range of 15 to 80 μm, measured under a microscope at a cross section of the treated part of the preform in polarized light.

The measuring method under a microscope at a cross section of the bottom area in polarized light is described in more detail in the Examples section.

“A complete outer layer” means here a surface area which is completely covered by the solvent induced crystallized PET.

In case of the PET bottle the complete outer layer is preferably at every position of the parts with amorphous PET material or parts where the PET material has an insufficient degree of crystallinity, like at the bottom area and/or the neck area.

In case of the PET preform the complete outer layer is preferably at every position of the parts of the preform which will be transformed—by stretch blow molding—to parts of the stretch blow molded bottle where its PET material is unstretched or just slightly stretched, i.e. where its PET material would be amorphous or would have an insufficient degree of crystallinity if the preform would not be pretreated.

In a preferred embodiment the bottle according to the invention is at a pressure above 1 bar at least in part filled with a chemical substance or a composition comprising the chemical substance, the chemical substance being selected from the group consisting of alcohols, ketones, aldehydes, esters, natural flavor enhancers, or mixtures thereof.

In context of the present invention the following substances are of particular relevance as they represent typical substances which can be present in containers for consumer compositions and/or as they are known to be able to cause stress cracking: Alcohols like C₂-C₁₂ saturated and unsaturated aliphatic, cyclic and/or aromatic alcohols, ethoxylated alcohols, particularly ethanol, isopropanol, propylene glycol, dimethyl octenol, 1-phenyl-2-ethanol, ketons like C₃-C₅ aliphatic linear and/or cyclic ketones, particularly acetone, methy ethyl ketone, methyl propyl ketone; aldehydes like C₇-C₁₀ aliphatic saturated and unsaturated aldehydes, particularly heptanal, decanal, octenal, esters based on C₁-C₁₀ saturated and unsaturated linear and/or cyclic alcohols and C₂-C₄ acids, particularly ethylacetate, amylacetate, butyl cyclohexyl acetate, acetic acid phenylmethyl ester, benzylacetate, and natural flavor enhancers like mono terpene alcohols, particularly eugenol, eugenolacetate, geraniol, geranyl ester, citronellol, citral, linalyl acetate, jasmonates, salicylates, and derivatives thereof.

It should be mentioned that in context of the present invention PET bottles are of interest having a filling volume in the range of 10 to 1500 ml, preferably 20 to 1000 ml, and most preferably in the range of 50 to 750 ml. At least PET bottles having these sizes benefit from the inventive treatment described herein. Nonetheless, also PET bottles of smaller or greater size should benefit from the present invention if the treatment conditions are adapted accordingly.

In a preferred embodiment of the invention the bottle is at least in part filled with the chemical substance or the composition mentioned above at a pressure above 1.5 bar, more preferably in the range of 3 to 20 bar, most preferably in the range of 5 to 15 bar, measured at a temperature of 50° C.

Finally, a further aspect of the invention is the use of the specific PET described above for the manufacture of a stretch blow molded PET bottle or a PET preform intended to be used for the manufacture of a stretch blow molded PET bottle by stretch blow molding the preform, preferably wherein the stretch blow molded PET bottle is intended to be treated with an organic solvent or an aqueous solution of an organic solvent in order to improve the resistance of the bottle to environmental stress cracking.

In the following some remarks and definitions are added which might help—if needed at all—to clarify some issues disclosed and discussed above.

The “parts of the stretch blow molded PET bottle where its PET material is amorphous or has an insufficient degree of crystallinity” as herein referred to means a) those parts of the bottle where the degree of crystallinity of the PET material compared to the maximum degree of crystallinity present at any part of the bottle is less than 20%, preferably less than 30%, more preferably less than 40%, or b) those parts of the bottle where the absolute degree of crystallinity of the PET material is less than 6%, preferably less than 9%, more preferably less than 12%, determined by the density method as described in the Examples section.

An insufficient degree of crystallinity—in context of the present invention—typically appears at those parts of a bottle where its PET material is unstretched or only slightly stretched, i.e. where the strain induced crystallization has not reached a degree for imparting the bottle with a sufficient resistance to environmental stress cracking. Typical parts of a PET bottle having an insufficient degree of crystallinity are at the bottom area and at the neck area of a PET bottle. As only these parts need to be treated with the organic solvent or the aqueous solution of the organic solvent mentioned above these parts have been defined as above. Both definitions under a) and b) characterize more or less the same parts of a bottle since a typical maximum absolute degree of crystallinity present at any part of such a bottle is about 30% determinable by the mentioned density method. So, the invention is carried out if at least those parts of a PET bottle are treated falling under one of the definitions mentioned under a) or b).

For determining the relative degree of crystallinity defined under a) any appropriate method for determining a degree of crystallinity can be used if for every measurement the same method is used. However, also for alternative b) the density method as mentioned above is preferred.

“A stretch blow molded PET bottle” or simply a “PET bottle” as herein referred to means a PET bottle which has been manufactured by a method comprising the step of stretch blow molding a PET preform to obtain the PET bottle. The manufacturing process of stretch blow molding a preform under obtaining a bottle is well known to a person skilled in the art and needs not to be described in detail here.

“The bottom area of a bottle” as herein referred to means those parts of a stretch blow molded PET bottle where its PET material is amorphous or has an insufficient degree of crystallinity near the injection gate of the former preform used for making the bottle.

“The neck area of a bottle” as herein referred to means those parts of a stretch blow molded PET bottle where its PET material is amorphous or has an insufficient degree of crystallinity near the threaded closure of the bottle.

A “preform” as herein referred to means an injection molded item that is meant to be stretch blow molded into a bottle, the material the preform and the bottle are made of is preferably PET.

“Improved resistance to environmental stress cracking” as herein referred to means fewer and/or less distinctive microscopic and/or macroscopic stress cracks at unstretched or just slightly stretched parts of a PET bottle having been treated with the organic solvent or the aqueous solution of the organic solvent prior to the application of a stress cracking provoking chemical substance compared to the number and/or distinctness of stress cracks of an equal PET bottle having not been treated with the organic solvent or the aqueous solution of the organic solvent.

The FIGS. 1 to 8 are given to further illustrate the invention:

FIG. 1 shows three tensile bones made of PET having increasing molecular weight (top-down 1 to 3) without solvent pretreatment but after bending and applying acetone as stress cracking provoking chemical substance (1: PET I, 2: PET II, 3: PET III).

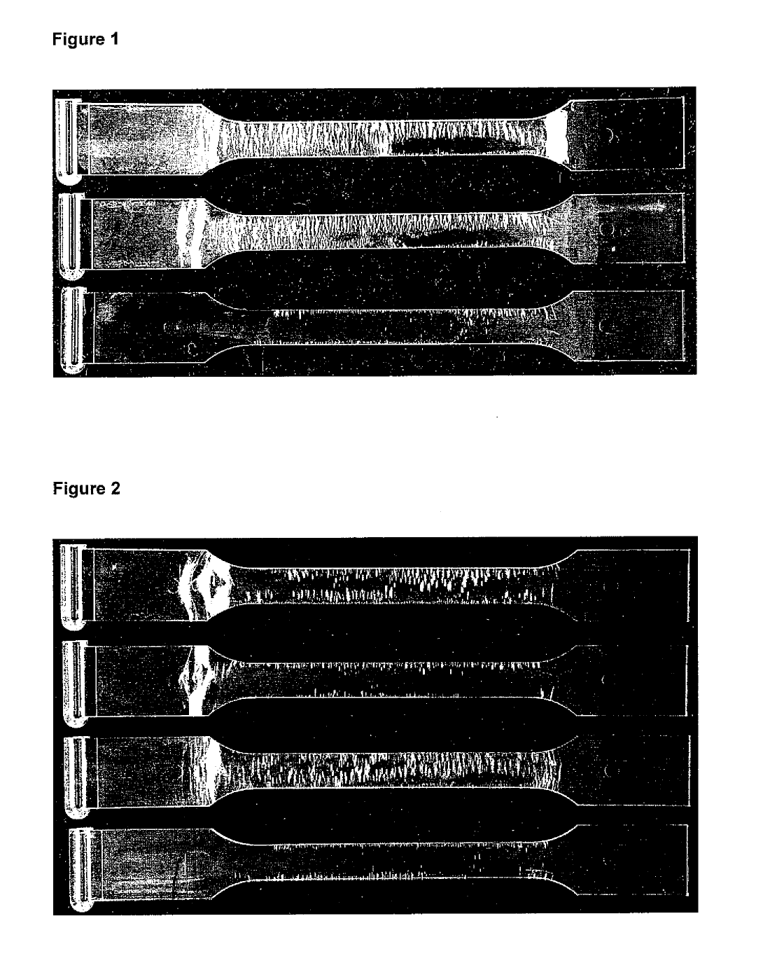

FIG. 2 shows four tensile bones made of PET containing different amounts of DEC and IPA (top-down 1 to 4) without solvent pretreatment but after bending and applying acetone as stress cracking provoking chemical substance (1: PET V, 2: PET VI, 3: PET VII, 4: PET VIII).

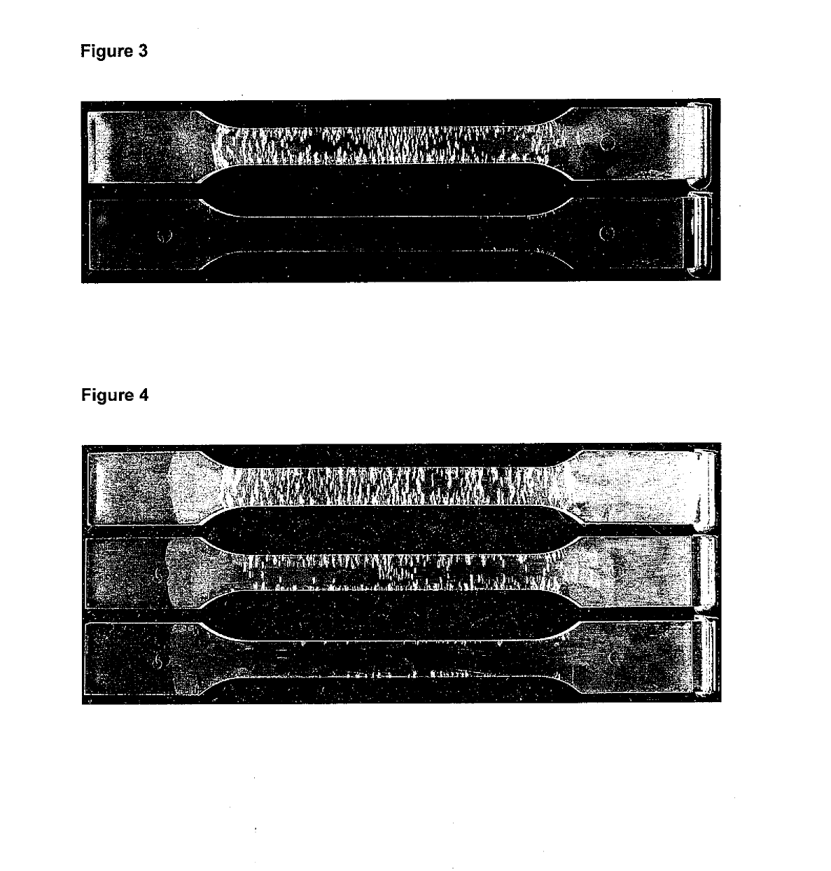

FIG. 3 shows two tensile bones made of PET without any PeOH and of a PET with 300 ppm by weight PeOH (top-down 1 to 2) without solvent pretreatment but after bending and applying acetone as stress cracking provoking chemical substance (1: PET 2: PET IX).

FIG. 4 shows three tensile bones made of PET I without any PeOH and of PET X and PET XI having different amounts of PeOH (top-down 1 to 3) without solvent pretreatment but after bending and applying acetone as stress cracking provoking chemical substance (1: PET I; 2: PET X; 3: PET XI).

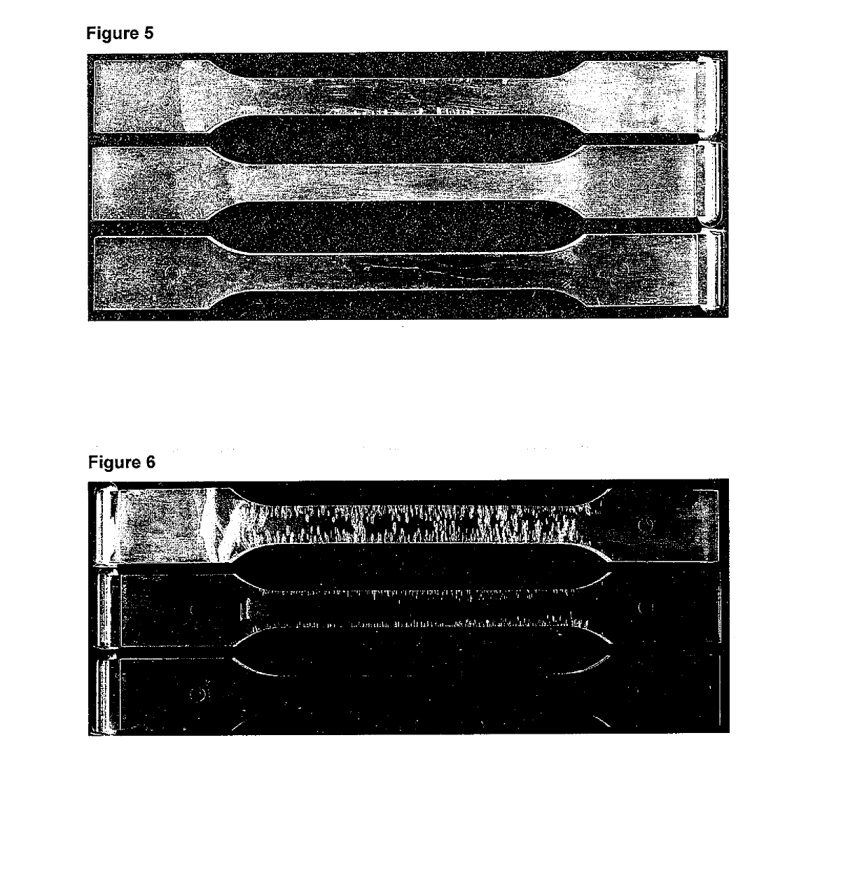

FIG. 5 shows three tensile bones made of PET having increasing molecular weight (top-down 1 to 3) in combination with a high PeOH content (300 ppm by weight) without solvent pretreatment but after bending and applying acetone as stress cracking provoking chemical substance (1: PET XI, 2: PET IX; 3: PET IV).

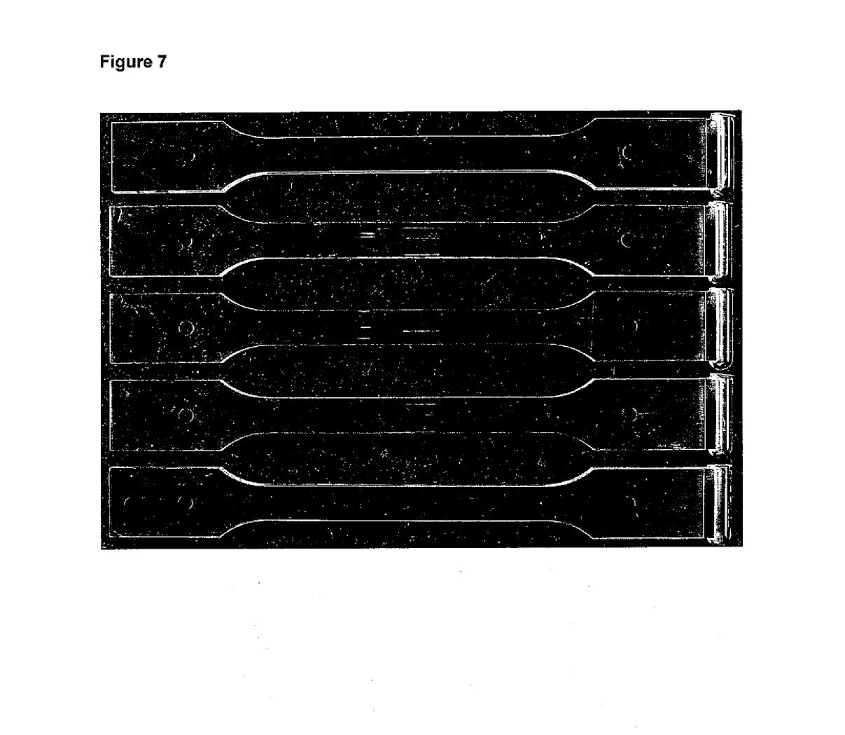

FIG. 6 shows three tensile bones made of PET having increasing molecular weight (top-down 1 to 3) in combination with a high PeOH content (300 ppm by weight) without solvent pretreatment but after bending and applying acetone as stress cracking provoking chemical substance (1: PET 2: PET III; 3: PET IV).

FIG. 7 shows five tensile bones made of PET IV after pretreating them in various mixtures of acetone and water (top-down 1 to 5) for 5 seconds followed by bending and applying acetone as stress cracking provoking chemical substance (1: without treatment; 2: acetone/water 50:50 vol-%; 3: acetone/water 60:40 vol-%; 4: acetone/water 70:30 vol-%; 5: acetone/water 80:20 vol-%).

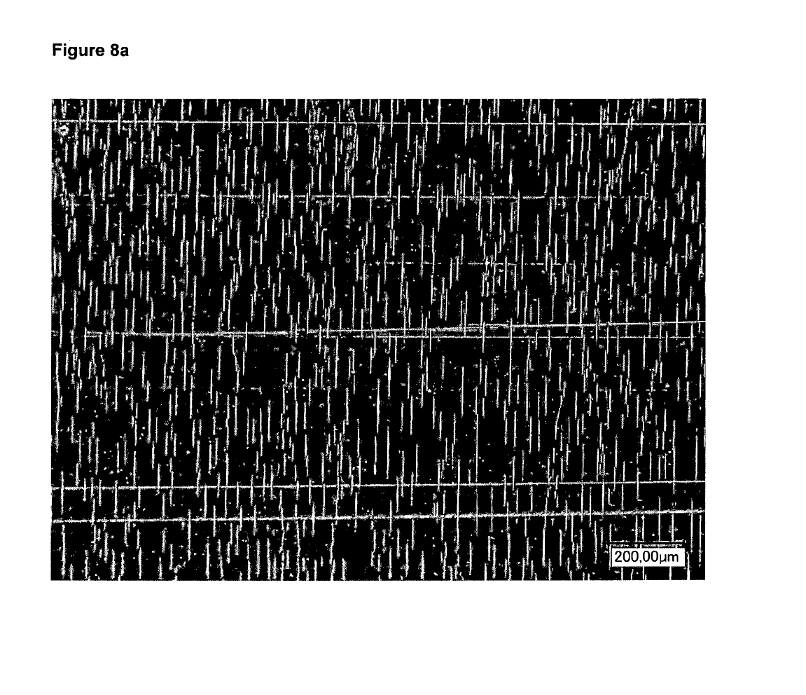

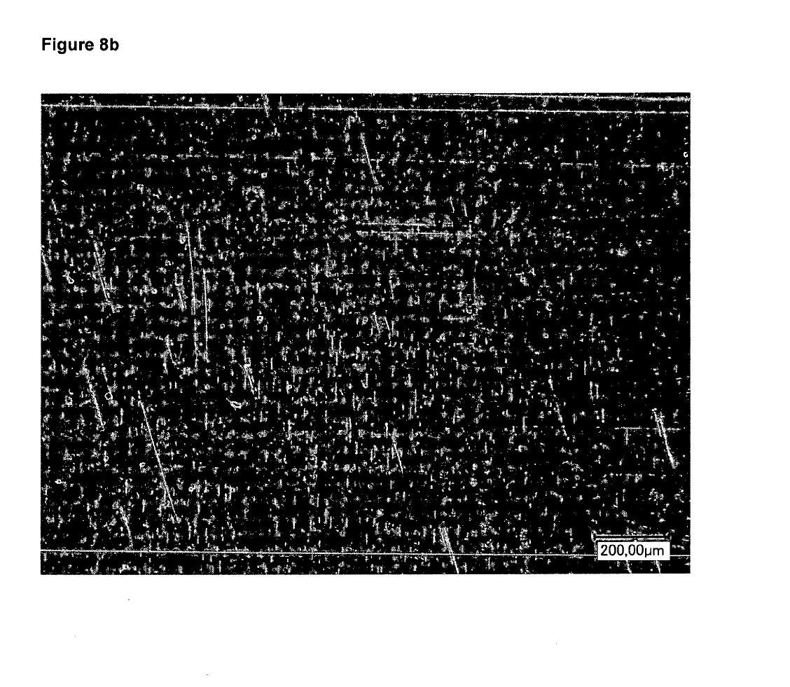

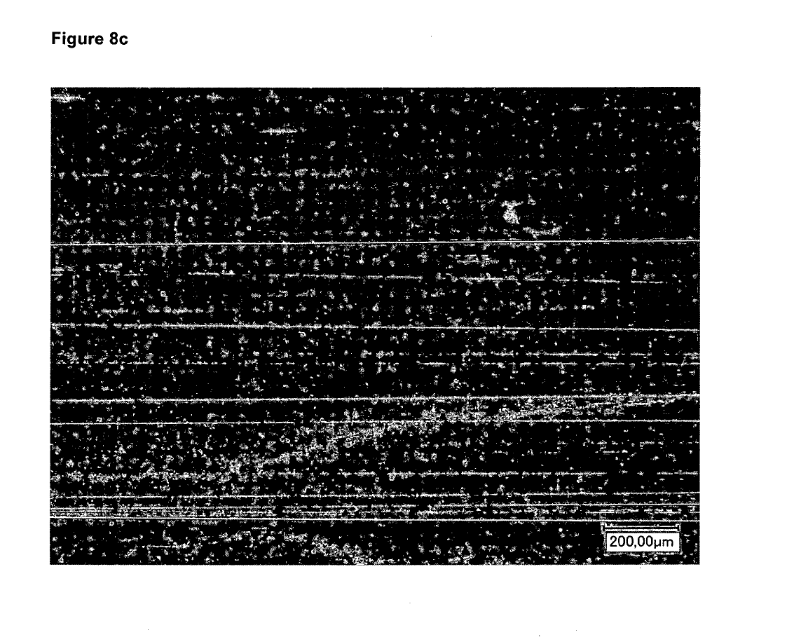

FIGS. 8a-c show the first three tensile bones made of PET IV of FIG. 7 under a microscope without and with pretreatment after bending and applying acetone as stress cracking provoking chemical substance (FIG. 8a: without treatment; FIG. 8b: acetone/water 50:50 vol-%; FIG. 8c: acetone/water 60:40 vol-%).

### EXAMPLES

The following non-limiting Examples illustrate various features and characteristics of the present invention, which is not to be construed as limited thereto.

### Example 1

### Comparison of the Impact of Various Types of PET

Each of three tensile bones made of various types of PET was at first considerably bended but without causing mechanical cracks and then over poured with 1 ml acetone as stress cracking provoking chemical substance. Shortly after relaxing each tensile bone each of the pictures shown in FIG. 1 was made.

The various types of PET were:

Tensile bone 1: PET I,

Tensile bone 2: PET II, and

Tensile bone 3: PET III.

Example 1 demonstrates that stress cracking can be reduced by increasing the molecular weight of the PET.

### Example 2

### Comparison of the Impact of Different Amounts of DEC and IPA in PET

Each of four tensile bones made of PET containing different amounts of DEC and IPA was at first considerably bended but without causing mechanical cracks and then 1 ml acetone was poured over each bended tensile bone as stress cracking provoking chemical substance. Shortly after relaxing each tensile bone each of the pictures shown in FIG. 2 was made.

The PET containing different amounts of DEC and IPA were:
Tensile bone 1: 3 wt % DEC, 2 wt % IPA (PET V);
Tensile bone 2: 2 wt % DEC, 2 wt % IPA (PET VI);
Tensile bone 3: 2 wt % DEC, 3 wt % IPA (PET VII); and
Tensile bone 4: 2 wt % DEC, 1 wt % IPA (PET VIII).

Example 2 demonstrates that stress cracking can be reduced by decreasing the comonomer content of the PET.

### Example 3

### Comparison of the Impact of PeOH in PET on Environmental Stress Cracking

Each of two tensile bones made of PET II having no PeOH and of PET IX containing 300 ppm PeOH was at first considerably bended but without causing mechanical cracks and then 1 ml acetone was poured over each bended tensile bone as stress cracking provoking chemical substance. Shortly after relaxing each tensile bone each of the pictures shown in FIG. 3 was made.

The PET containing different amounts of PeOH were:
Tensile bone 1: 0 wt % PeOH (PET II), and
Tensile bone 2: 300 wt % PeOH (PET IX).

Example 3 demonstrates that stress cracking can be reduced when PeOH is present in the PET as comonomer.

### Example 4

### Comparison of the Impact of Different Amounts of PeOH in PET

Each of three tensile bones made of PET containing different amounts of PeOH was at first considerably bended but without causing mechanical cracks and then 1 ml acetone was poured over each bended tensile bone as stress cracking provoking chemical substance. Shortly after relaxing each tensile bone each of the pictures shown in FIG. 4 was made.

The PET containing different amounts of PeOH were:
Tensile bone 1: PET I without PeOH,
Tensile bone 2: PET X with 150 ppm by weight PeOH, and
Tensile bone 3: PET XI with 300 ppm by weight PeOH.

Example 4 demonstrates that stress cracking can be further reduced when the amount of PeOH as comonomer in the PET is increased.

### Example 5

### Comparison of the Impact of Various Types PET having Different Molecular Weight in Combination with PeOH

Each of three tensile bones made of various types PET was at first considerably bended but without causing mechanical cracks and then 1 ml acetone was poured over each bended tensile bone as stress cracking provoking chemical substance. Shortly after relaxing each tensile bone each of the pictures shown in FIG. 5 was made.

The PET were:
Tensile bone 1: PET I,
Tensile bone 2: PET II, and
Tensile bone 3: PET IV.

Example 5 demonstrates that best stress cracking performance can be achieved when the PET has a high IV in combination with a high content of PeOH as comonomer.

### Example 6

### Comparison of the Impact of Different Amounts of PeOH, of DEC and IPA and of Different IV in PET

Each of three tensile bones made of various types PET was at first considerably bended but without causing mechanical cracks and then 1 ml acetone was poured over each bended tensile bone as stress cracking provoking chemical substance. Shortly after relaxing each tensile bone each of the pictures shown in FIG. 6 was made.

The PET were:
Tensile bone 1: PET II,
Tensile bone 2: PET III, and
Tensile bone 3: PET IV.

Example 6 demonstrates that best stress cracking performance can be achieved when the PET has a high IV in combination with a high content of PeOH as comonomer and a lower DEC and IPA content.

### Example 7

### Comparison of the Impact of Different Mixtures of Stress Cracking Provoking Chemical Substances when Treating Tensile Bones

Each of five tensile bones made of PET IV was pretreated by immerging the tensile bones in different mixtures of acetone/water for 5 seconds. Thereafter, each of the tensile bone was considerably bended but without causing mechanical cracks and then 1 ml acetone was poured over each bended tensile bone as stress cracking provoking chemical substance. Shortly after relaxing each tensile bone each of the pictures shown in FIG. 7 was made. Additionally, from tensile bones 1 to 3 pictures were made under a microscope (FIGS. 8a-c).

The treatment conditions were:
Tensile bone 1: without treatment,
Tensile bone 2: acetone/water 50:50 vol-%,
Tensile bone 3: acetone/water 60:40 vol-%,
Tensile bone 4: acetone/water 70:30 vol-%, and
Tensile bone 5: acetone/water 80:20 vol-%,

Example 7 demonstrates that even an unpretreated PET but having a high IV in combination with a high content of PeOH and a low content of DEC and IPA as comonomers does not show macroscopic stress cracks (cracks visible without microscope) after being bended and treated with acetone as stress cracking provoking chemical substance. After pretreatment with acetone/water with at least 50 vol-% acetone also the microscopic cracks disappear. So, the best result is achieved if a pretreatment is applied in combination with the use of a specific type of PET.

### Example 8

### Manufacture, Characteristics and Properties of a Typical PET (PET IV) According to the Present Invention

The PET IV was synthesized in an antimony catalyzed polycondensation reaction of PTA, MEG, IPA, DEC and PeOH (260 ppm by weight Sb based on elemental Sb in final polymer). The comonomer contents of the resulting polymer were 0.5% by weight IPA, 1.5% by weight DEC and 0.03% by weight PeOH. The intrinsic viscosity IV was 1.06 dl/g and the acid number was 18 mmol/kg.

### Experimental Results

### Measuring Layer Thickness of Solvent Induced Crystallized PET

Thin slices (20 μm thick) of the cross-section of tensile bones were taken by using a microtom HM 355 S from Microm. The thin slices were embedded in Canada balsam between a microscope slide and a cover glass. The determination of the thickness of the solvent induced crystalline layer was done using the digital microscope system VHX-1000 from Keyence and the zoom lens VH-Z250R in polarized light.

### Determining the Absolute Degree of Crystallization (Density Method)

Starting from the completely amorphous material having a density of 1.331 g/cm³ and the 100% crystalline material having a density of 1.445 g/cm³ the crystallinity of the respective part of the bottle is interpolated from the measured values of the density. The density was determined by using a density gradient column according to ISO 1183-2:2004.

### Characteristics of Various PETs Used in the Examples

| | DEG | IPA | IV | PeOH |
|---|---|---|---|---|
| PET | [wt-%] | [wt-%] | [dl/g] | [wt-ppm] |
| PET I | 1.8 | 1.0 | 0.80 | 0 |
| PET II | 1.8 | 1.0 | 0.85 | 0 |
| PET III | 1.8 | 1.0 | 1.06 | 0 |
| PET IV | 1.5 | 0.5 | 1.06 | 300 |
| PET V | 3.0 | 2.0 | 0.80 | 0 |
| PET VI | 2.0 | 2.0 | 0.80 | 0 |
| PET VII | 2.0 | 3.0 | 0.80 | 0 |
| PET VIII | 2.0 | 1.0 | 0.80 | 0 |
| PET IX | 1.8 | 1.0 | 0.85 | 300 |
| PET X | 1.8 | 1.0 | 0.80 | 150 |
| PET XI | 1.8 | 1.0 | 0.80 | 300 |

What is claimed is:

1-13. (canceled)

14. A polyethylene terephthalate (PET) comprising:
from 0 to 2.5% by weight IPA;
from 1% to 2% by weight DEG; and
from 0.005% to 0.1% by weight PeOH,
each based on the weight of the PET.

15. The PET of claim 14, wherein the PET has an intrinsic viscosity (IV) in the range of 0.8 dl/g to 1.2 dl/g.

16. The PET of claim 14, wherein the PET has an intrinsic viscosity (IV) in the range of 0.9 dl/g to 1.1 dl/g.

17. The PET of claim 14, wherein the PET has an a-value in the range of 0.25 to 0.45.

18. The PET of claim 14, wherein the PET has an a-value in the range of 0.30 to 0.40.

19. The PET of claim 14, wherein the PET is manufactured by the use of one or more long chain branching agents present in a polycondensation reaction, the one or more long chain branching agents selected from the group comprising tri- and tetrafunctional polyols.

20. A preform formed from a PET comprising:
from 0 to 2.5% by weight IPA;
from 1% to 2% by weight DEG; and
from 0.005% to 0.1% by weight PeOH,
each based on the weight of the PET,
wherein the preform is suitable for the manufacture of a PET bottle by stretch blow molding the preform.

21. A stretch blow molded bottle formed from a PET comprising:
from 0 to 2.5% by weight IPA;
from 1% to 2% by weight DEG; and
from 0.005% to 0.1% by weight PeOH,
each based on the weight of the PET.

22. The stretch blow molded bottle of claim 21, wherein the manufacture of the stretch blow molded bottle includes treating the stretch blow molded bottle with an organic solvent or an aqueous solution of the organic solvent to improve the resistance of the stretch blow molded PET bottle to environmental stress cracking.

23. A method of manufacturing a treated stretch blow molded PET bottle having an improved resistance to environmental stress cracking, the method comprising:
forming a stretch blow molded bottle from a PET comprising:
from 0 to 2.5% by weight IPA;
from 1% to 2% by weight DEG; and
from 0.005% to 0.1% by weight PeOH,
each based on the weight of the PET; and
treating at least parts of the stretch blow molded bottle where the PET is amorphous or has an insufficient degree of crystallinity with either:
an organic solvent, or
an aqueous solution of the organic solvent for a time in the range one second to less than one hour.

24. The method of claim 23,
wherein treating at least parts of the stretch blow molded bottle includes treating with the organic solvent,
wherein the organic solvent is selected from the group consisting of at least one of acetone, ethyl acetate, methyl propyl ketone, toluene, 2-propanol, pentane, methanol, and combinations thereof.

25. The method of claim 23,
wherein treating at least parts of the stretch blow molded bottle includes treating with the aqueous solution of the organic solvent,
wherein the aqueous solution of the organic solvent is a mixture of water with an organic solvent selected from the group consisting of at least one of acetone, ethyl acetate, methyl propyl ketone, toluene, 2-propanol, pentane, methanol, and combination thereof.

26. A method of manufacturing a treated stretch blow molded PET bottle having improved resistance to environmental stress cracking, the method comprising:
providing a preform of the treated stretch blow molded PET bottle,
treating, with an organic solvent or an aqueous solution of the organic solvent, at least those parts of the preform or the which after stretch blow molding in parts of the PET bottle where the PET material would be amorphous or would have an insufficient degree of crystallinity if the perform were not treated, and
stretch blow molding the treated preform with a PET to obtain the stretch blow molded PET bottle, wherein the PET comprises:
from 0 to 2.5% by weight IPA;
from 1% to 2% by weight DEG; and
from 0.005% to 0.1% by weight PeOH,
each based on the weight of the PET.

27. The method of claim 26,
wherein treating at least parts of the preform includes treating with the organic solvent,
wherein the organic solvent is selected from the group consisting of at least one of acetone, ethyl acetate, methyl propyl ketone, toluene, 2-propanol, pentane, methanol, and combinations thereof.

28. The method of claim 26,
wherein treating at least parts of the preform includes treating with the aqueous solution of the organic solvent,
wherein the aqueous solution of the organic solvent is a mixture of water with an organic solvent selected from the group consisting of at least one of acetone, ethyl acetate, methyl propyl ketone, toluene, 2-propanol, pentane, methanol, and combination thereof,

29. A treated stretch blow molded PET bottle having improved resistance to environmental stress cracking, prepared by a process comprising the steps of:
providing a preform of the treated stretch blow molded PET bottle;
treating, with an organic solvent or an aqueous solution of the organic solvent, at least the parts of the preform or the PET bottle which, after stretch blow molding the PET bottle from the preform, the PET material would be amorphous or would have an insufficient degree of crystallinity if the perform were not treated; and
stretch blow molding the preform with a PET to obtain the PET bottle, wherein the PET comprises:
from 0 to 2.5% by weight IPA;
from 1% to 2% by weight DEG; and
from 0.005% to 0.1% by weight PeOH,
each based on the weight of the PET.

30. The treated stretch blow molded PET bottle of claim 29, wherein the treated stretch blow molded PET bottle has an outer layer of solvent induced crystallized PET with a thickness in the range of 3 to 200 μm.

31. The treated stretch blow molded PET bottle of claim 29, wherein the process further comprises filling the treated stretch blow molded PET bottle, at least in part, with a chemical composition comprising the chemical substance, the chemical substance being selected from the group consisting of: alcohols, ketones, aldehydes, esters, natural flavor enhancers, and mixtures thereof,
wherein, after the filling, the treated stretch blow molded PET bottle is at a pressure above 1 bar.

32. The method of claim 29,
wherein treating at least the parts of the preform or the PET bottle includes treating at least the preform with the organic solvent or the aqueous solution of the organic solvent.

33. The method of claim 29,
wherein treating at least the parts of the preform or the PET bottle includes treating at least the PET bottle with the organic solvent or the aqueous solution of the organic solvent.
